(19) United States
(12) Patent Application Publication
(10) Pub. No.: US 2014/0011068 A1
(43) Pub. Date: Jan. 9, 2014

(54) NON-AQUEOUS ELECTROLYTE SECONDARY BATTERY

(71) Applicants: Noriko Yamashita, Tokushima (JP); Masato Iwanaga, Tokushima (JP)

(72) Inventors: Noriko Yamashita, Tokushima (JP); Masato Iwanaga, Tokushima (JP)

(73) Assignee: SANYO ELECTRIC CO., LTD., Moriguchi-shi, Osaka (JP)

(21) Appl. No.: 14/006,119

(22) PCT Filed: Mar. 21, 2012
(86) PCT No.: PCT/JP2012/057108

§ 371 Date: Sep. 19, 2013

(30) Foreign Application Priority Data
Mar. 29, 2011 (JP) 2011-072716

(51) Int. Cl. H01M 2/16

(52) U.S. Cl. CPC H01M 2/1673
USPC 429/145

(57) ABSTRACT

A non-aqueous electrolyte secondary battery comprising a positive electrode plate contains a positive electrode active material capable of absorbing and releasing lithium reversibly, a negative electrode plate containing a negative electrode active material capable of absorbing and releasing lithium reversibly, a separator keeping the positive electrode plate and the negative electrode plate isolated, and a non-aqueous electrolytic solution containing a non-aqueous solvent and an electrolyte salt, wherein the positive electrode plate has a surface on which an inorganic particle layer containing inorganic particles and a binder is formed, and the separator is a polyolefin microporous film including a laminate film having at least two layers and containing inorganic particles in at least a negative-electrode-side surface layer thereof. This configuration can improve storage properties and reduce swelling under high-temperature environment.

### TECHNICAL FIELD

The present invention relates to a nonaqueous electrolyte secondary battery and particularly relates to a nonaqueous electrolyte secondary battery having superior high-temperature storage properties and cycling properties.

### BACKGROUND ART

As a power supply for driving modern mobile electronic instruments such as a mobile phone, mobile personal computer, or mobile music player and further as a power supply for hybrid electric vehicles (HEVs) or electric vehicles (EVs), a nonaqueous electrolyte secondary battery represented by a lithium-ion secondary battery having high energy density and with high capacity is extensively utilized.

As a positive electrode active material of these nonaqueous electrolyte secondary batteries, a material capable of reversibly absorbing and desorbing lithium ions, for example, a single one of or a mixture of a plurality of LiCoO₂, LiNiO₂, LiNiₓCo₁₋ₓO₂ (x=0.01 to 0.99), LiMnO₂, LiCoₓMn_{y}Ni_{z}O₂ (x+y+z=1), LiMn₂O₄, and LiFePO₄, is used.

Of these, lithium-cobalt composite oxides and lithium-cobalt composite oxide with dissimilar metal elements added thereto are commonly used because they are particularly superior to other materials in various battery properties. However, cobalt is expensive, and the existing amount as a resource is small. It is therefore required to further improve performance of non:Igneous electrolyte secondary batteries for continuing using such lithium-cobalt composite oxides and lithium-cobalt composite oxide with dissimilar metal elements added thereto as a positive electrode active material of the nonaqueous electrolyte secondary batteries.

Increasing a charge termination voltage can be considered as a method of increasing the capacity of a nonaqueous electrolyte secondary battery in which such a lithium-cobalt composite oxide is used as a positive electrode active material. However, increasing the charge termination voltage can cause the problem of deteriorating cyclic properties and storage properties. Such deterioration of cyclic properties and storage properties due to an increased charge termination voltage is known to be particularly remarkable under high-temperature environments. Although the detailed mechanism is unclear, analyzing nonaqueous electrolyte secondary batteries with deteriorated cyclic properties and storage properties shows an increase in the amount of degradation products from the electrolyte and leakage of the positive electrode active material elements into the electrolyte. These events are assumed to be factors in the deterioration of cyclic properties and storage properties.

In regard to such problems, a method has been proposed by which an inorganic particle layer containing inorganic particles and a binder is provided between the positive electrode active material layer and the separator to improve storage properties and the cycling properties under high-temperature conditions. For example, Patent Document 1 and Patent Document 2 below each disclose a nonaqueous electrolyte secondary battery in which an inorganic particle layer as a covering of a positive electrode active material layer.

### RELATED ART DOCUMENTS

### Patent Documents

Patent Document 1: JP-A-2007-134279

Patent Document 2: JP-A-2007-280917

Patent Document 3: PCT Publication No. WO 2006/038532

### DISCLOSURE OF INVENTION

### Problem to be Solved by the Invention

However, providing an inorganic particle layer on the surface of the positive electrode active material layer increases the thickness of the battery in high-temperature storage, although it restrains degradation of the electrolyte, leakage of elements from the positive electrode active material layer, and oxidation reaction of the separator and consequently prevents self-discharge in high-temperature storage and capacity drop in cycles.

Patent Document 3 above discloses a polyolefin microporous membrane that contains polyethylene and polypropylene and includes a multilayer film having two or more layers, as a separator for a lithium ion battery that has improving effects of impregnation with electrolyte, mechanical strength, permeability and high-temperature storage properties when it is used in a battery. In the polyolefin microporous membrane, at least a surface layer on one side contains an inorganic particle. However, Patent Document 3 does not consider a case of using the polyolefin microporous membrane that includes a multilayer film having two or more layers and has at least a surface layer on one side containing inorganic particles as a separator in a nonaqueous electrolyte secondary battery with an inorganic particle layer provided on the surface of a positive electrode active material layer. In addition, Patent Document 3 does not suggest anything about effects on change in the thickness of the battery in high-temperature storage.

The inventors of the present invention have examined the causes of increase in the thickness of a battery in high-temperature storage when an inorganic particle layer is arranged on the surface of the positive electrode active material layer. As a result, they have found that the inorganic particle layer arranged on the surface of the positive electrode active material layer is likely to hold the electrolyte and consequently oxidation decomposition of the electrolyte is likely to occur on the surface side of the positive electrode active material layer.

The inventors of the present invention have also found that providing an inorganic particle layer on the negative electrode side as well prevents an excessive amount of the electrolyte from being held on the positive electrode side and thus prevents the oxidation decomposition of the electrolyte, which is specifically seen on the positive electrode side. Thus, the present invention has been completed.

The present invention provides a nonaqueous electrolyte secondary battery which has both improved storage properties and reduced swelling under high-temperature environments.

### Means for Solving Problem

To achieve the object described above, a nonaqueous electrolyte secondary battery of the present invention includes: a positive electrode plate containing a positive electrode active material capable of absorbing and desorbing lithium reversibly; a negative electrode plate containing a negative electrode active material capable of absorbing and desorbing lithium reversibly; a separator keeping the positive electrode plate and the negative electrode plate isolated; and a nonaqueous electrolyte containing a nonaqueous solvent and an electrolyte salt. In the nonaqueous electrolyte secondary battery, the positive electrode plate has a surface on which an inorganic particle layer containing inorganic particles and a binder is formed; and the separator is a polyolefin microporous film including a laminate film having at least two layers and containing inorganic particles in at least a negative-electrode-side surface layer thereof.

In the nonaqueous electrolyte secondary battery of the invention, a positive electrode active material layer has a surface on which an inorganic particle layer is formed. In addition, the separator is a microporous film including a laminate film having at least two layers and containing inorganic particles in a surface layer thereof. Consequently, storage properties under high-temperature environments are improved. Furthermore, gas generation due to forming the inorganic particle layer on the surface of the positive electrode active material layer is prevented. Thus, a nonaqueous electrolyte secondary battery can be obtained that has improved storage properties and reduces swelling under high-temperature environments.

In the invention, the polyolefin microporous film used as the separator preferably contains polyethylene because this provides superior permeability and shutdown properties for a separator. In addition, the content of the inorganic particles in the surface layer of the separator is preferably from 3 to 60% by mass inclusive. The effect of adding the organic particle is less likely to appear with a small content. Furthermore, a large content increases rigidity of the separator, which lowers productivity because the separator is likely to become tangled up in equipment when being rolled up. The content of the inorganic particles in the surface layer is, therefore, more preferably from 5 to 40% by mass inclusive.

The effect of forming the inorganic particle layer on the surface of the positive electrode plate can be successfully obtained when the inorganic particle layer has a thickness of 0.1 μm or more. When the inorganic particle layer has a thickness larger than 4 μm, load properties are deteriorated due to increase in resistance inside the battery. The energy density of the battery is also decreased due to decrease in the active material amounts of the positive electrode plate and the negative electrode plate. In the nonaqueous electrolyte secondary battery of the invention, therefore, the inorganic particle layer has a thickness of from 0.1 to 4 μm inclusive.

It is preferable to use at least any of an oxide or a nitride of silicon, aluminum, and titanium as the inorganic particles contained in the inorganic particle layers formed on at least the negative-electrode-side surface layer and the surface of the positive electrode plate of the separator. It is more preferable to use silicon dioxide, aluminum oxide, and titanium oxide.

The positive electrode active material that can be used in the nonaqueous electrolyte secondary battery of the invention is not limited in any way as long as it is a material capable of absorbing and desorbing lithium reversibly. A positive electrode active material that has been generally used as above may be used. The negative electrode active material that can be used in the nonaqueous electrolyte secondary battery of the invention is not limited in any way as long as it is a material capable of absorbing and desorbing lithium reversibly. For example, the following materials may be used: a carbon material such as graphite, non-graphitizable carbon, and graphitizable carbon; a titanium oxide such as LiTiO₂ and TiO₂; a metalloid element such as silicon and tin: and a Sn—Co alloy.

Examples of a nonaqueous solvent that can be used for the nonaqueous electrolyte secondary battery of the invention include: a cyclic carbonate such as ethylene carbonate (EC), propylene carbonate (PC), and butylene carbonate (BC); a fluorinated cyclic carbonate; a cyclic carboxylic ester such as γ-butyrolactone (γ-BL) and γ-valerolactone (γ-VL); a chain carbonate such as dimethyl carbonate (DMC), ethyl methyl carbonate (EMC), diethyl carbonate (DEC), methylpropyl carbonate (MPC), and dibutyl carbonate (DBC), a fluorinated chain carbonate; a chain carboxylic ester such as methyl pivalate, ethyl pivalate, methyl isobutyrate, and methyl propionate; an amide compound such as N,N′-dimethylformamide and N-methyl oxazolidinone; a sulfur compound such as sulfolane; and an ambient-temperature molten salt such as tetrafluombolic acid and 1-ethyl-3-methylimidazolium. It is desirable that two or more of them be mixed to be used. Among these, it is preferable to use a mixture of a cyclic carbonate and a chain carbonate in view of permittivity and ion conductivity.

Within the nonaqueous electrolyte used in the nonaqueous electrolyte secondary battery of the invention, the following compounds may be further added as compounds for stabilization of an electrode: vinylene carbonate (VC), vinyl ethyl carbonate (VEC), succinic anhydride (SUCAH), maleic anhydride (MAAH), glycolic anhydride, ethylene sulfite (ES), divinyl sulfone (VS), vinyl acetate (VA), vinyl pivalate (VP), catechol carbonate, and biphenyl. Two or more of these compounds can also be mixed for use as appropriate.

In the nonaqueous electrolyte secondary battery of the invention, a lithium salt that is commonly used as an electrolyte salt for a nonaqueous electrolyte secondary battery may be used as an electrolyte salt. Examples of such a lithium salt are as follows: LiPF₆ (lithium hexafluorophosphate), LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, and mixtures of these substances. Among them LiPF₆ is preferable in particular. The amount of dissolution of the solute with respect to the nonaqueous solvent described above is preferably 0.5 to 2.0 mol/L.

In the nonaqueous electrolyte secondary battery of the invention, the nonaqueous electrolyte may be not only in liquid form but also in a gel.

### BEST MODE(S) FOR CARRYING OUT THE INVENTION

An embodiment for carrying out the present invention will be described below in detail using examples and comparative examples. The examples below show examples of a nonaqueous electrolyte secondary battery for embodying the technical idea of the present invention and is not intended to specify the present invention as the examples. The present invention is equally applicable to various modifications without departing from the technical idea shown in the scope of claims.

First, a specific manufacturing method of a nonaqueous electrolyte secondary battery of each example and comparative example will be described.

### [Preparation of Positive Electrode Active Material]

A mixture of a lithium cobalt oxide with a dissimilar element added thereto and a layer lithium nickel-manganese-cobalt oxide was used as the positive electrode active material. The lithium cobalt oxide with a dissimilar element added thereto was prepared as follows. The following materials were used as starting materials: lithium carbonate (Li₂CO₃) as a lithium source; and tricobalt tetroxide (Co₃O₄) with Zr and Mg added thereto as a cobalt source. Tricobalt tetroxide with Zr and Mg was obtained as follows: coprecipitation was performed at the time of synthesizing cobalt carbonate in a solution in which 0.2 mol % of Zr and 0.5 mol % of Mg were added as dissimilar elements to Co; and subsequently, thermal decomposition reaction was performed. Lithium carbonate and tricobalt tetroxide with Zr and Mg added thereto were weighed in particular amounts and mixed. The resultant substance was baked in an air atmosphere at 850° C. for 24 hours, thereby obtaining lithium cobalt oxide with Zr and Mg added thereto. This substance was pulverized using a mortar into particles having an average particle diameter of 14 μm, thereby obtaining a positive electrode active material A.

The layer lithium nickel-manganese-cobalt oxide was prepared as follows. As starting materials, Li₂CO₃ was used as a lithium source, and a coprecipitated hydroxide represented by Ni_{0.33}Mn_{0.33}Co_{0.34}(OH)₂ was used as a transition metal source. These materials were weighed in particular amounts and mixed. Subsequently the resultant substance was baked in an air atmosphere at 1000° C. for 20 hours, thereby obtaining a layer lithium nickel-manganese-cobalt oxide represented by LiNi_{0.33}Mn_{0.33}Co_{0.34}O₂. This substance was pulverized using a mortar into particles having an average particle diameter of 5 μm, thereby obtaining a positive electrode active material B. The positive electrode active material A and the positive electrode active material B thus obtained were mixed at a mass ratio of 7:3 to obtain the positive electrode active material used in the nonaqueous electrolyte secondary battery of the examples and comparative examples.

[Preparation of Positive Electrode Plate]

A slurry was prepared by mixing 94 parts by mass of the positive electrode active material obtained as above, 3 parts by mass of a carbon powder as a conducting agent, and 3 parts by mass of polyvinylidene fluoride (PVdF) powder as a binding agent, and mixing the resultant substance with an N-methylpyrrolidone (NMP) solution. This slurry was applied by a doctor blade method to both surfaces of a positive electrode collector formed of aluminum with a thickness of 15 μm, and then dried. Subsequently through compression using a compression roller, a positive electrode plate that has the short side of 36.5 mm and is used in the examples and comparative examples was prepared.

[Formation of Inorganic Particle Layer]

An inorganic particle layer was also formed as follows on the surface of the positive electrode plate obtained as above for the nonaqueous electrolyte secondary batteries of Examples 1 to 4 and Comparative Example 1. Acetone was used as a solvent. Based on acetone, 10% by mass of rutile-type titanium oxide (TiO₂: KR380 produced by Titan Kogyo, Ltd.) having a particle diameter of 0.38 μm was mixed as inorganic particles. Based on titanium oxide, 10% by mass of a copolymer (a rubber-like polymer) including an acrylonitrile structure (unit) was mixed as a binding agent. Mixed dispersion treatment was performed using Filmics produced by Tokushu Kika Kogyo Co., Ltd., thereby preparing titanium oxide-dispersed slurry. By using this slurry, an inorganic particle layer of titanium oxide was layered on both surfaces of the positive electrode plate through die-coating. The solvent was dried and removed, thereby forming the inorganic particle layer on both surfaces of the positive electrode plate.

The inorganic particle layers of Examples 1 to 3 and Comparative Example 1 had a thickness of 4 μm. The inorganic particle layer of Example 4 had a thickness of 0.1 μm.

These thicknesses are the thicknesses of each inorganic particle layer provided on one side of the positive electrode plate.

[Preparation of Negative Electrode Plate]

A slurry was prepared by dispersing 96 parts by mass of graphite as a negative electrode active material, 2 parts by mass of carboxymethyl cellulose as a thickening agent, 2 parts by mass of styrene-butadiene rubber (SBR) as a binding agent into water. This slurry was applied by a doctor blade method to both surfaces of a negative electrode corrector formed of copper with a thickness of 8 μm and then was dried, thereby forming a negative electrode active material layer on both surfaces of the negative electrode collector. Next, through compression using a compression roller, a negative electrode plate that has the short side of 37.5 mm and is commonly used in the examples and comparative examples was prepared.

The potential of graphite is about 0.1 V relative to Lithium as the reference. The filling amount of the active materials of the positive electrode plate and the negative electrode plate was adjusted such that the charge capacity ratio (negative electrode charge capacity/positive electrode charge capacity) of the positive electrode plate and the negative electrode plate is 1.1 at the potential of the positive electrode active material that is the design reference.

[Preparation of Nonaqueous Electrolyte]

LiPF₆ was dissolved at 1.0 mol/L into a mixed solution in which ethylene carbonate (EC), diethyl carbonate (DEC), and methyl ethyl carbonate (MEC) were mixed at 20:30:50 (volume ratio), thereby preparing the nonaqueous electrolyte used in the nonaqueous electrolyte secondary batteries of the examples and comparative examples.

[Preparation of Separator]

### EXAMPLES 1 TO 4 AND COMPARATIVE EXAMPLE 2

A polyethylene microporous film having three layers was used as a separator used in the nonaqueous electrolyte secondary batteries of Examples 1 to 4 and Comparative Example 2. A raw material of the two layers corresponding to surfaces was a substance obtained by mixing polyethylene and silicon dioxide (SiO₂) as inorganic particles at various mass ratios (86:14 for Example 1, 95:5 for Example 2, 60:40 for Example 3, 86:14 for Example 4, and 86:14 for Comparative Example 2) and stirring the mixture with a blender. A raw material of the intermediate layer sandwiched by the surface layers was polyethylene. Each of the raw materials of the surface layer and the intermediate layer was kneaded with liquid paraffin as a plasticizing agent. The layers were each kneaded and heat-melted, and molded by a coextrusion method into a sheet having three layers so as to form a separator in which layers containing inorganic particles were arranged as surface layers on both sides. Subsequently, the resultant object was extended, the plasticizing agent was extracted and removed, and the resultant object was dried and extended. Thus, the polyethylene microporous film having three layers was prepared in which the two surface layers were each 2 μm of thickness and the intermediate layer was 10 μm of thickness, as a separator used in the examples and Comparative Example 2.

### COMPARATIVE EXAMPLES 1 AND 3

Polyethylene was used as a raw material of the separator used in the nonaqueous electrolyte secondary batteries of Comparative Examples 1 and 3, and was kneaded with liquid paraffin as a plasticizing agent. Subsequently, the resultant substance was heat-melted and extruded to be molded into a sheet, thereby preparing the separator. The separator thus obtained contains no inorganic particles, and has a single layer structure of polyethylene.

[Preparation of Battery]

The separator for each example and comparative example was interposed between the positive electrode plate and the negative electrode plate for each example and comparative example, and the object was wound, thereby preparing a wound electrode assembly. The wound electrode assembly was stored into a metal prismatic outer can. Subsequently, the electrolyte described above was poured into the outer can thereby preparing a prismatic nonaqueous electrolyte secondary battery (thickness of 5.5 mm×width of 34 mm×height of 43 mm) according to each example and comparative example. The nonaqueous electrolyte secondary battery thus obtained had a design capacity of 800 mAh.

[High-Temperature Storage Test]

The batteries of the examples and comparative examples were charged under an environment of 25° C. with a constant current of 1 It=800 mA until the battery voltage reached 4.4 V (the positive electrode voltage was 4.5 V relative to lithium as the reference). After the battery voltage reached 4.4 V, the batteries were charged with a constant voltage of 4.4 V until the charge current readied 1/40 It=20 mA, thereby obtaining frilly Charged batteries. Subsequently the batteries were discharged at a constant current of 1 It=800 mA until the battery voltage reached 3.0 V. The discharge capacities at this time point were measured as the initial capacity.

The batteries were charged under an environment of 25° C. at a constant current of 1 It=800 mA. After the battery voltage reached 4.4 V, the batteries were charged with a constant voltage of 4.4 V until the charge current reached 1/40 It=20 mA, thereby obtaining full-charged batteries. The fully charged batteries were stored for 20 days in a thermostat chamber in which the temperature was kept 60° C.

The batteries after the storage for 20 days were cooled until the battery temperature reached 25° C., and the battery thickness was measured with a vernier caliper. Subsequently, the batteries were discharged under an environment of 25° C. at a constant current of 1 It=800 mA until the battery voltage reached 3.0 V. The discharge capacities were measured as after-storage capacities under the same conditions as those of the measurement of the initial capacities. The capacity return rates were obtained from a formula below

Capacity return rate(%)=(After-storage capacity)/(Initial capacity)×100

Table 1 shows the results of the capacity return rates and the battery thicknesses after high-temperature charge storage.

TABLE 1

| | | | Capacity return | Battery |
|---|---|---|---|---|
| | | | rate after | thickness |
| | Positive | Content of | high- | after high- |
| | electrode | inorganic | temperature | temperature |
| | inorganic | particles in | charge | charge |
| | particle layer | separator | storage | storage |
| | (μm) | (%) | (%) | (mm) |
| Example 1 | 4 | 14 | 88 | 5.68 |
| Example 2 | 4 | 5 | 87 | 5.69 |
| Example 3 | 4 | 40 | 88 | 5.65 |
| Example 4 | 0.1 | 14 | 83 | 5.64 |
| Comparative | 4 | 0 | 85 | 5.91 |
| Example 1 | | | | |
| Comparative | 0 | 14 | 70 | 5.66 |
| Example 2 | | | | |
| Comparative | 0 | 0 | 66 | 5.65 |
| Example 3 | | | | |

The battery of Comparative Example 3, in which the positive electrode active material layer had no surface on which an inorganic particle layer was formed, had an inferior capacity return rate. This shows that the battery deteriorated fast under high-temperature environments.

In contrast, the battery of Comparative Example 1, in which the positive electrode active material layer had a surface on which the inorganic particle layer was formed, had an improved capacity return rate after high-temperature charge storage compared with the battery of Comparative Example 3. This shows that storage properties under high-temperature environments are improved by forming an inorganic particle layer on a surface of the positive electrode active material layer. However, while having improved storage properties under high-temperature environments, the battery of Comparative Example 1 had a largely increased battery thickness.

This is assumed to be occur by a mechanism below. Specifically, the inorganic particle layer arranged on the surface of the positive electrode active material layer is likely to hold the electrolyte. Consequently, in the battery of Comparative Example 1, oxidation decomposition of the electrolyte was facilitated on the surface side of the positive electrode active material layer, and thus gas due to decomposition of the electrolyte was likely to occur.

In contrast, the batteries of Examples 1 to 4 had more improved capacity return rates after high-temperature charge storage than the battery of Comparative Example 1. Furthermore, the batteries of Examples 1 to 4 had smaller increase in the battery thickness than the battery of Comparative Example 3. As described above, storage properties under high-temperature environments are improved and gas generation due to forming the inorganic particle layer is prevented by forming an inorganic particle layer on a surface of a positive electrode active material layer and using, as the separator, a microporous film including a laminate film having at least two layers and containing inorganic particles in a surface layer thereof. Thus, it is assumed that swelling of the battery is reduced.

A result of comparison between Comparative Example 2 and Comparative Example 3 shows that an effect of reducing a battery thickness is not obtained by merely using a microporous film containing inorganic particles in the surface layer as a separator, in comparison with the case of using a microporous film containing no inorganic particles. This shows that the effect of the invention of improving storage properties and reducing swelling of the battery under high-temperature environments is a synergistic effect that can be provided only by forming an inorganic particle layer on a surface of the positive electrode active material layer and using, as a separator, a multi-layered microporous film including a laminate film having at least two layers and :containing inorganic particles in a surface layer thereof.

In the examples described above, a microporous film having three layers that can be reliably manufactured in view of a film forming process was used as the separator. However, a similar effect to that of the invention can be obtained in principal as long as the separator is a microporous film including a laminate film having at least two layers and containing inorganic particles in a negative-electrode-side surface layer thereof.

The content of the inorganic particles in the surface layer of the separator is preferably from 3 to 60% by mass inclusive. However, the effect of adding the organic particle is less likely to appear with a small content. Furthermore, a large content increases rigidity of the separator, which lowers productivity because the separator is likely to become tangled up in equipment when being rolled up. The content of the inorganic particles in the surface layer is, therefore, more preferably from 5 to 40% by mass inclusive.

In the examples described above, silicon dioxide was used as the inorganic particles contained in the surface layer of the separator. However, a material that is insulating and unlikely to react with the electrolyte may be used. An oxide or a nitride of silicon, aluminum, and titanium may be used as inorganic particles to be contained. Of these, silicon dioxide and aluminum oxide are preferable.

The effect of forming the inorganic particle layer on the surface of the positive electrode plate can be successfully obtained when the inorganic particle layer has a thickness of 0.1 μm or more. When the inorganic particle layer has a thickness larger than 4 μm, load properties are deteriorated due to increase in resistance inside the battery. The energy density of the battery is also decreased due to decrease in the active material amounts of the positive electrode plate and the negative electrode plate. In the nonaqueous electrolyte secondary battery of the invention, therefore, the inorganic particle layer has a thickness of from 0.1 to 4 μm inclusive.

In the examples described above, a mixture of a lithium cobalt oxide with a dissimilar element added thereto and a layer lithium nickel-manganese-cobalt oxide was used as the positive electrode active material. However, the invention is equally applicable to a case of using a material that has been generally used and is capable of absorbing and desorbing lithium reversibly, such as LiCoO₂, LiNiO₂, LiNiₓCo₁₋ₓO₂ (x=0.01 to 0.99), LiMnO₂, LiMn₂O₄, LiNiₓMn_{y}Co_{z}O₂ (x+y+z=1), and LiFePO₄.

In the examples described above, a prismatic nonaqueous electrolyte secondary battery including a flattened wound electrode assembly was used as an example. However, the invention does not depend on the shape of the electrode assembly of the nonaqueous electrolyte secondary battery. The invention is, therefore, applicable to a circular or elliptical nonaqueous electrolyte secondary battery including a wound electrode assembly and to a stacked nonaqueous electrolyte secondary battery in which a positive electrode plate and a negative electrode plate are stacked with a separator interposed therebetween.

1. A nonaqueous electrolyte secondary battery comprising:
a positive electrode plate containing a positive electrode active material capable of absorbing and desorbing lithium reversibly;
a negative electrode plate containing a negative electrode active material capable of absorbing and desorbing lithium reversibly;
a separator keeping the positive electrode plate and the negative electrode plate isolated; and
a nonaqueous electrolyte containing a nonaqueous solvent and an electrolyte salt,
the positive electrode plate having a surface on which an inorganic particle layer containing inorganic particles and a binder is formed; and
the separator being a polyolefin microporous film including a laminate film having at least two layers and containing inorganic particles in at least a negative-electrode-side surface layer thereof.

2. The nonaqueous electrolyte secondary battery according to claim 1, wherein the content of the inorganic particles in the surface layer is from 5 to 40% by mass inclusive.

3. The nonaqueous electrolyte secondary battery according to claim 1, wherein the inorganic particle layer has a thickness of from 0.1 to 4 μm inclusive.

4. The nonaqueous electrolyte secondary battery according to claim 2, wherein the inorganic particle layer has a thickness of from 0.1 to 4 μm inclusive.
